(19) United States
(12) Patent Application Publication
(10) Pub. No.: US 2005/0081200 A1
(43) Pub. Date: Apr. 14, 2005

(54) Data processing system having multiple processors, a task scheduler for a data processing system having multiple processors and a corresponding method for task scheduling

(76) Inventors: Martijn Johan Rutten, Eindhoven (NL); Josephus Theodorus Johannes Van Eijndhoven, Eindhoven (NL); Evert-Jan Daniel Pol, Eindhoven (NL)

Correspondence Address: Philips Electronic North Americas Corporation;Corporate Patent Counsel, PO Box 3001, Briarcliff Manor, NY, 10510, US

(21) Appl. No.: 10/498,298

(22) PCT Filed: Dec. 5, 2002
(86) PCT No.: PCT/IB02/05199

(30) Foreign Application Priority Data
Dec. 14, 2001 (EP) 01204882.3

(51) Int. Cl. G06F 9/46

(52) U.S. Cl. 718/100

(57) ABSTRACT

The invention is based on the idea to provide distributed task scheduling in a data processing system having multiple processors. Therefore, a data processing system comprising a first and at least one second processor for processing a stream of data objects, wherein said first processor passes data objects from a stream of data objects to the second processor, and a communication network and a memory is provided. Said second processors are multi-tasking processors, capable of interleaved processing of a first and second task, wherein said first and second tasks process a first and second stream of data objects, respectively. Said data processing system further comprises a task scheduling means for each of said second processors, wherein said task scheduling means is operatively arranged between said second processor and said communication network, and controls the task scheduling of said second processor.

The invention relates to a data processing system having multiple processors, and a task scheduler for a data processing system having multiple processors and a corresponding method for task scheduling.

A heterogeneous multiprocessor architecture for high performance, data-dependent media processing e.g. for high-definition MPEG decoding is known. Media processing applications can be specified as a set of concurrently executing tasks that exchange information solely by unidirectional streams of data. G. Kahn introduced a formal model of such applications already in 1974, ‘The Semantics of a Simple Language for Parallel Programming’, Proc. of the IFIP congress 74, August 5-10, Stockholm, Sweden, North-Holland publ. Co, 1974, pp. 471-475 followed by an operational description by Kahn and MacQueen in 1977, ‘Co-routines and Networks of Parallel Programming’, Information Processing 77, B. Gilchhirst (Ed.), North-Holland publ., 1977, pp 993-998. This formal model is now commonly referred to as a Kahn Process Network.

An application is known as a set of concurrently executable tasks. Information can only be exchanged between tasks by unidirectional streams of data. Tasks should communicate only deterministically by means of a read and write actions regarding predefined data streams. The data streams are buffered on the basis of a FIFO behaviour. Due to the buffering two tasks communicating through a stream do not have to synchronise on individual read or write actions.

In stream processing, successive operations on a stream of data are performed by different processors. For example a first stream might consist of pixel values of an image, that are processed by a first processor to produce a second stream of blocks of DCT (Discrete Cosine Transformation) coefficients of 8×8 blocks of pixels. A second processor might process the blocks of DCT coefficients to produce a stream of blocks of selected and compressed coefficients for each block of DCT coefficients.

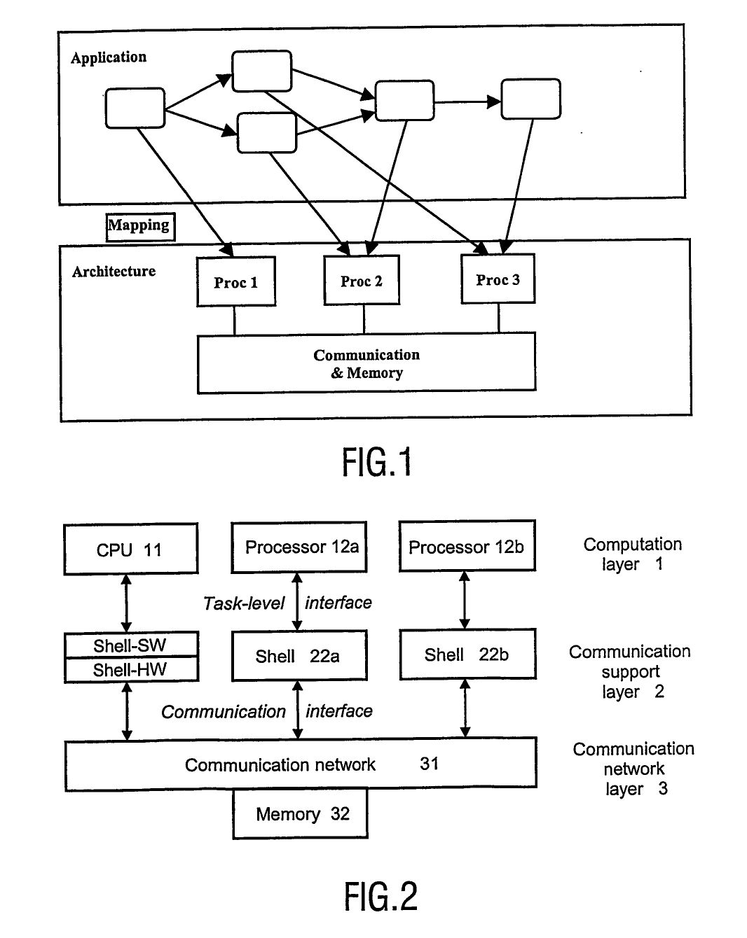

FIG. 1 shows a illustration of the mapping of an application to a processor as known from the prior art. In order to realise data stream processing a number of processors are provided, each capable of performing a particular operation repeatedly, each time using data from a next data object from a stream of data objects and/or producing a next data object in such a stream. The streams pass from one processor to another, so that the stream produced by a first processor can be processed by a second processor and so on. One mechanism of passing data from a first to a second processor is by writing the data blocks produced by the first processor into the memory.

The data streams in the network are buffered. Each buffer is realised as a FIFO, with precisely one writer and one or more readers. Due to this buffering, the writer and readers do not need to mutually synchronize individual read and write actions on the channel. Reading from a channel with insufficient data available causes the reading task to stall. The processors can be dedicated hardware function units which are only weakly programmable. All processors run in parallel and execute their own thread of control. Together they execute a Kahn-style application, where each task is mapped to a single processor. The processors allow multi-tasking, i.e., multiple Kahn tasks can be mapped onto a single processor.

It is an object of the invention to improve the operation of a Kahn-style data processing system.

This object is solved by a data processing system according to claim 1, a task scheduler according to claim 19 and a corresponding method for task scheduling according to claim 32.

The invention is based on the idea to provide distributed task scheduling in a data processing system having multiple processors. Therefore, a data processing system comprising a first and at least one second processor for processing a stream of data objects, wherein said first processor passes data objects from a stream of data objects to the second processor, and a communication network is provided. Said second processors are multi-tasking processors, capable of interleaved processing of a first and second task, wherein said first and second tasks process a first and second stream of data objects, respectively. Said data processing system further comprises a task scheduling means for each of said second processors, wherein said task scheduling means is operatively arranged between said second processor and said communication network, and controls the task scheduling of said second processor.

A distributed task scheduling where each second processor has its own task scheduler is advantageous since it allows the second processor to be autonomous, which is a prerequisite for a scalable system.

In an aspect of the invention said task scheduling means determines the next task to be processed by said second processor upon receiving a request from said second processor and forwards an identification of said next task to said second processor. Said second processor requests a next task at predetermined intervals, wherein said intervals representing the processing steps of said second processor. Thus a non-preemptive task scheduling can be realised.

In a preferred aspect of the invention said task scheduling means comprises a stream table and a task table. Said stream table is used for storing parameters of each stream associated with the tasks mapped on the associated processor, wherein said parameter include an amount of valid data for reading, an amount of available room for writing, information on whether the running task is blocked on reading or writing to said stream, and/or configuration information relating said stream to a task. Said task table is used for administrating the different tasks associated to said second processor, wherein said task table contains an index to the stream table indicating which streams are associated to said task, an enable flag for each task indicating whether the task is allowed to mm, and/or a budget counter indicating an available processing budget for each task. The provision of a stream table and a task table in the task scheduling means associated to second processor improves the local controlling and administration capabilities of the data processing system.

In still another aspect of the invention said task scheduling means checks all streams in said stream table and determines which of said streams allow task progress. A stream allows progress if a) the stream has valid data for reading or available room for writing, b) the task did not request more valid data or room than is available in the stream, and/or c) option a), b) are configured as irrelevant for task progress.

In a further aspect of the invention said task scheduling means checks tasks in said task table and determines which of said tasks are allowed to run. A task is allowed to run if all the streams associated to said task are allowed to run and the enable flag of said task is set.

In still another aspect of the invention said task scheduling means selects a task which is to be processed next after the current task, upon receiving a request from said second processor, wherein the current task is allowed to continue if the current task is still allowed to run and a budget counter in said task table is nonzero. Otherwise the next task as determined by said task scheduling means is selected as current task and the budget counter is reset. Thus it is guarantied that each task mapped to a second processor regularly gets the opportunity to execute on the second processor.

In another aspect of the invention said task scheduling means selects a task which is to be processed next before said second processor request a next task, so that the identification of the selected next task can be immediately returned to said second processor. Accordingly, the processing speed of the data processing system is increased.

In still another aspect of the invention said task scheduling means comprises a budget counter means for controlling the budget counters of the current task. The provision of a budget counter for each task ensures the implementation of justice within the processing of different tasks.

The invention also relates to a task scheduler for a data processing system. Said system comprises a first and at least one second processor for processing a stream of data objects, said first processor being arranged to pass data objects from a stream of data objects to the second processor, a communication network and a memory. The task scheduler is associated to one of said second processors, is operatively arranged between said second processor and said communication network; and controls the task scheduling of said associated second processor.

The invention also relates to a method for task scheduling in a data processing system. Said system comprises a first and at least one second processor for processing a stream of data objects, said first processor being arranged to pass data objects from a stream of data objects to the second processor, and a communication network. Said system comprises a task scheduler for each of said second processors. The task scheduler controls the task scheduling of said second processor.

In an aspect of the invention the task scheduler is implemented on a programmable second processor.

Further embodiments of the invention are described in the dependent claims.

These and other aspects of the invention are described in more detail with reference to the drawings; the figures showing:

FIG. 1 an illustration of the mapping of an application to a processor according to the prior art;

FIG. 2 a schematic block diagram of an architecture of a stream based processing system;

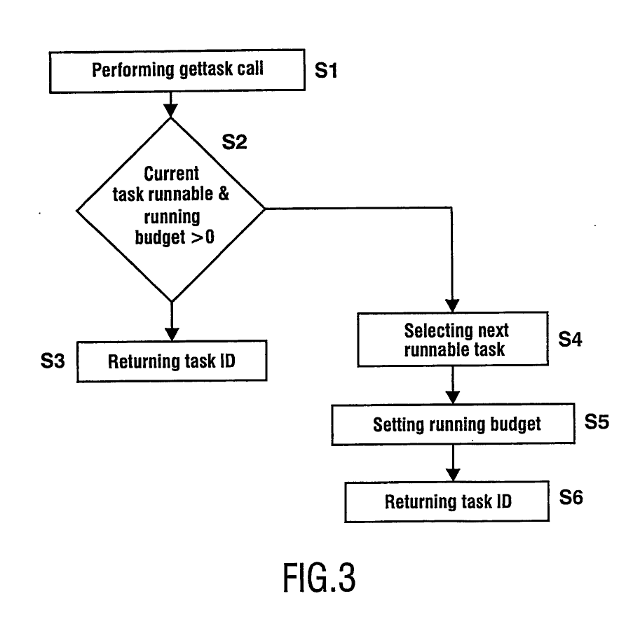

FIG. 3a flow chart of a task switching process according to the preferred embodiment;

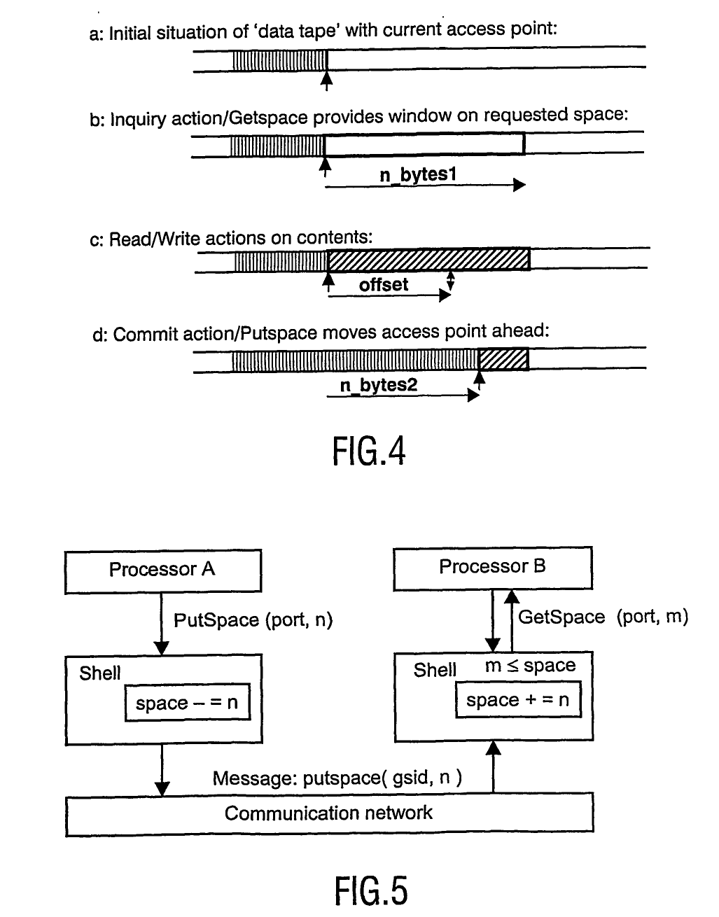

FIG. 4 an illustration of the synchronising operation and an I/O operation in the system of FIG. 2; and

FIG. 5 a mechanism of updating local space values in each shell according to FIG. 2.

FIG. 2 shows a processing system for processing streams of data objects according to a preferred embodiment of the invention. The system can be divided into different layers, namely a computation layer 1, a communication support layer 2 and a communication network layer 3. The computation layer 1 includes a CPU 11, and two processors or coprocessors 12a, 12b. This is merely by way of example, obviously more processors may be included into the system. The communication support layer 2 comprises a shell 21 associated to the CPU 11 and shells 22a, 22b associated to the processors 12a, 12b, respectively. The communication network layer 3 comprises a communication network 31 and a memory 32.

The processors 12a, 12b are preferably dedicated processor; each being specialised to perform a limited range of stream processings. Each processor is arranged to apply the same processing operation repeatedly to successive data objects of a stream. The processors 12a, 12b may each perform a different task or function, e.g. variable length decoding, run-length decoding, motion compensation, image scaling or performing a DCT transformation. In operation each processor 12a, 12b executes operations on one or more data streams. The operations may involve e.g. receiving a stream and generating another stream or receiving a stream without generating a new stream or generating a stream without receiving a stream or modifying a received stream. The processors 12a, 12b are able to process data streams generated by other processors 12b, 12a or by the CPU 11 or even streams that have generated themselves. A stream comprises a succession of data objects which are transferred from and to the processors 12a, 12b via said memory 32.

The shells 22a, 22b comprise a first interface towards the communication network layer being a communication layer. This layer is uniform or generic for all the shells. Furthermore the shells 22a, 22b comprise a second interface towards the processor 12a, 12b to which the shells 22a, 22b are associated to, respectively. The second interface is a task-level interface and is customised towards the associated processor 12a, 12b in order to be able to handle the specific needs of said processor 12a, 12b. Accordingly, the shells 22a, 22b have a processor-specific interface as the second interface but the overall architecture of the shells is generic and uniform for all processors in order to facilitate the re-use of the shells in the overall system architecture, while allowing the parameterisation and adoption for specific applications.

The shell 22a, 22b comprise a reading/writing unit for data transport, a synchronisation unit and a task switching unit. These three units communicate with the associated processor on a master/slave basis, wherein the processor acts as master. Accordingly, the respective three unit are initialised by a request from the processor. Preferably, the communication between the processor and the three units is implemented by a request-acknowledge handshake mechanism in order to hand over argument values and wait for the requested values to return. Therefore the communication is blocking, i.e. the respective thread of control waits for their completion.

The reading/writing unit preferably implements two different operations, namely the read-operation enabling the processors 12a, 12b to read data objects from the memory and the write-operation enabling the processor 12a, 12b to write data objects into the memory 32. Each task has a predefined set of ports which correspond to the attachment points for the data streams. The arguments for these operations are an ID of the respective port ‘port_id’, an offset ‘offset’ at which the reading/writing should take place, and the variable length of the data objects ‘n_bytes’. The port is selected by a ‘port_id’ argument. This argument is a small non-negative number having a local scope for the current task only.

The synchronisation unit implements two operations for synchronisation to handle local blocking conditions on reading from an empty FIFO or writing to an full FIFO. The first operation, i.e. the getspace operation, is a request for space in the memory implemented as a FIFO and the second operation, i.e. a putspace operation, is a request to release space in the FIFO. The arguments of these operations are the ‘port_id’ and ‘n-bytes’ variable length.

The getspace operations and putspace operations are performed on a linear tape or FIFO order of the synchronisation, while inside the window acquired by the said the operations, random access read/write actions are supported.

The task switching unit implements the task switching of the processor as a gettask operation. The arguments for these operations are ‘blocked’, ‘error’, and ‘task_info’.

The argument ‘blocked’ is a Boolean value which is set true if the last processing step could not be successfully completed because a getspace call on an input port or an output port has returned false. Accordingly, the task scheduling unit is quickly informed that this task should better not be rescheduled unless a new ‘space’ message arrives for the blocked port. This argument value is considered to be an advice only leading to an improved scheduling but will never affect the functionality. The argument ‘error’ is a Boolean value which is set true if during the last processing step a fatal error occurred inside the processor. Examples from mpeg decode are for instance the appearance of unknown variable-length codes or illegal motion vectors. If so, the shell clears the task table enable flag to prevent further scheduling and an interrupt is sent to the main CPU to repair the system state. The current task will definitely not be scheduled until the CPU interacts through software.

Regarding the task-level interface between the shell 22 and the processor 12 the border between the shell 22 and the processor 12 is drawn bearing the following points in mind: The shell allows to re-use its micro-architecture for all processors. The shell has no semantic knowledge on function-specific issues. The shell forms an abstraction on the global communication system. Different tasks—from the processor point of view—are not aware of each other.

The operations just described above are initiated by read calls, write calls, getspace calls, putspace calls or gettask calls from the processor.

The system architecture according to FIG. 2 supports multitasking, meaning that several application tasks may be mapped to a single processor. A multitasking support is important in achieving flexibility of the architecture towards configuring a range of applications and reapplying the same hardware processors at different places in a data processing system. Clearly, multitasking implies the need for a task scheduling unit as the process that decides which task the processor must execute at which points in time to obtain proper application progress. The data processing system of the preferred embodiment is targeted at irregular data-dependent stream processing and dynamic workloads, task scheduling is not performed off-line but rather on-line, to be able to take actual circumstances into account. The task scheduling is performed at run-time as opposed to a fixed compile-time schedule.

Preferably, the processor 12 explicitly decides an the time instances during task execution at which it can interrupt the running task. This way, the hardware architecture does not need the provisions for saving context at arbitrary points in time. The processor can continue processing up to a point where it has little, or no state. These are the moments at which the processor can perform a task switch most easily.

At such moments, the processor 12 asks the shell 22 for which task it should perform the processing next. This inquiry is done through a gettask call. The intervals between such inquiries are considered as processing steps. Generally, a processing step involves reading in one or more packets of data, performing some operations an the acquired data, and writing out one or more packets of data.

The task scheduling unit resides in the shell 22 and implements the gettask functionality. The processor 12 performs a gettask call before each processing step. The return value is a task ID, a small nonnegative number that identifies the task context. Thus, upon request of the processor 12, the scheduler provides the next best suitable task to the processor 12. This arrangement can be regarded as non-preemptive scheduling with switch points provided by the processor 12. The scheduling unit cannot interrupt the processor 12; it waits for the processor 12 to finish a processing step and request a new task.

The task scheduling algorithm according to the invention should exhibits effectiveness for applications with dynamic workload, predictable behaviour an temporal overload situations, next task selection in a few clock cycles, and algorithmic simplicity, suitable for a cost effective hardware implementation in each shell.

Multi-tasking applications are implemented by instantiating appropriate tasks an multitasking processors. The behaviour of any task must not negatively influence the behaviour of other tasks that share the same processor. Therefore the scheduler prevents tasks that require more resources than assigned to hamper the progress of other tasks.

In the typical case, the sum of the workloads of all tasks preferably does not exceed the computation capacity of the processor to allow real-time throughput of media data streams. A temporary overload situation may occur in worst-case conditions for tasks with data dependent behaviour.

Round-robin style task selection suits our real-time performance requirements as it guarantees that each task is serviced at a sufficiently high frequency, given the short duration of a processing step.

The system designer assigns such resource budgets to each task at configuration time. The task scheduling unit must support a policing strategy to ensure budget protection. The scheduler implements policing of resource budgets by relating the budgets to exact execution times of the task. The scheduler uses time slices as the unit of measurement, i.e. a predetermined fixed number of cycles, typically in the order of the length of a processing step. The task budget is given as a number of time slices. The tack scheduler initialises the running budget to the budget of a newly selected task. The shell decrements the running budget of the active task alter every time slice. This way, the budget is independent of the length of a processing step, and the scheduler restricts the active task to the number of time slices given by its budget.

This implementation of budgets per task has a twofold usage: the relative budget values of the tasks that share a processor control the partitioning of compute resources over tasks, and the absolute budget values control task switch frequency, which influences the relative overhead for state save and restore.

The running budget is discarded when the active task blocks an communication. The next task starts immediately when the blocking task returns to the scheduling budget. This way, tasks with sufficient workload can use the excess computation time by spending their budget more often.

The absolute budgets of tasks in a processor determine the running time of these tasks, and therefore the task switch rate of the processor. In turn, the task switch rate of the processor relates to the buffer sizes for all its streams. A lower task switch rate means a longer sleep time for tasks, leading to larger buffer requirements. Thus, task switch rates should preferably be fairly high, and therefore a substantial task switch time is not acceptable. Ideally, task switch time for processors should be short compared to a single processing step so as to allow a task switch every time. This would allow the lowest absolute budgets and smallest stream buffers to be allocated.

Tasks according to the present invention have a dynamic workload. They can be data dependent in execution time, stream selection, and/or packet size. This data dependency influences the design of the scheduler, as it cannot determine in advance whether a task can make progress or not. The scheduling unit that performs a ‘Best guess’ is described as an embodiment according to the invention. This type of scheduler can be effective by selecting the right task in the majority of the cases, and recover with limited penalty otherwise. The aim of the scheduler is to improve the utilization of processors, and schedule such that tasks can make as much progress as possible. Due to the data dependent operation of the tasks, it cannot guarantee that a selected task can complete a processing step.

The task is runnable if there is at least some available workload for a task. The task enable flag is set if the task is configured to be active at configuration time. The schedule flag is also a configuration parameter, indicating per stream if the scheduler must consider the available space of this stream for the runnability of the task or not. The space parameter holds the available data or room in the stream, updated at run-time via the putspace operation. Alternatively, the blocked flag is set at run time if these was insufficient space an the last getspace inquiry of this task.

lf a task cannot make progress due to insufficient space, a getspace inquiry on one of its streams must have returned false. The shell 22a, 22b maintains per stream a blocked flag with the negation of the resulting value of the last getspace inquiry:

When such a blocked flag is raised, the task is not runnable anymore, and the task scheduling unit does not issue this task again at subsequent gettask requests until its blocked flag is reset. This mechanism helps the task scheduling unit to select tasks that can progress in the case that processor stream I/O selection or packet size is data dependent and cannot be predicted by the scheduler.

Note that after a failing getspace request, the active task can issue a second getspace inquiry for a smaller number of bytes, and thereby reset the blocked flag. The shell clears the blocked flag when an external ‘putspace’ increases the space for the blocked stream.

Task runnability is based an the available workload for the task. All streams associated which a task must have sufficient input data or output room to allow the completion of at least one processing step. The shell, including the task scheduling unit, does not interpret the media data and has no notion of data packets. Data packet sizes may vary per task and packet size can be data dependent. Therefore, the scheduler does not have sufficient information to guarantee success an getspace actions since it has no notion of how much space the task is going to request an which stream.

The scheduling unit issues a ‘Best guess’ by selecting tasks which at least some available workload for all associated streams, (i.e. space>0), regardless of how much space is available or required for task execution. Checking if these is some data or room available in the buffer—regardless of the amount suffices for the completion of a single processing step in—the cases that: The consuming and producing tasks synchronize at the same grain size. Therefore, if data or room is available, this is at least the amount of data or room that is necessary for the execution of one processing step. The consuming and producing tasks work an the same logical unit of operation, i.e., the same granularity of processing steps. For instance, if these is some but insufficient data in the buffer, this indicates that the producing task is currently active and that the missing data will arrive fast enough to allow the consuming task to wait instead of performing a task switch.

The selection of input or output streams can depend an the data being processed. This means that even if space=0 for some of the streams associated which a task, the task may still be runnable if it does not access these streams. Therefore, the scheduler considers the schedule flag for each stream. A false schedule flag indicates that it is unclear whether or not the task is going to access this stream, and that the scheduler must skip the space>0′ runnability test for this stream. However, if the task is selected and subsequently blocks on unavailable data or room in this stream, the blocked flag is set. Setting the blocked flag assures that the scheduling unit does not select this task again until also the blocked stream has at least some available space.

The processors should be as autonomous as possible for a scalable system. To this end, unsynchronised, distributed task scheduling unit are employed, where each processor shell has its own task scheduling unit. Processors are loosely coupled, implying that within the timescale that the buffer can bridge, scheduling of tasks an one processor is independent of the instantaneous scheduling of tasks an other processors. On a timescale larger than the buffer can bridge, the scheduling of tasks an different processors is coupled due to synchronization an data streams in shared buffers.

The system architecture according to FIG. 2 supports relatively high performance, high data throughput applications. Due to the limited size for on-chip memory containing the stream FIFO buffers, high data synchronization and task switch rates are required. Without the interrupt driven task switching of preemptive scheduling, the duration of processing steps must be kept small to allow sufficiently fine grained task switching. The processor-shell interface allows very high task switch rates to accommodate these requirements and can be implemented locally and autonomously without the need of an intervention from a main CPU. Preferably, gettask calls are performed at a rate of once every ten to one thousand clock cycles, corresponding to a processing step duration in the order of a microsecond.

FIG. 3 shows a flow chart of a task scheduling process according to the preferred embodiment on the basis of the data processing system according to FIG. 2. However, the presence of the read/write unit and the synchronisation unit in the shell 22 is not necessary is this embodiment.

The task scheduling process is initiated in step S1 by the processor 12a performing a gettask call directed to the scheduling unit in the shell 22a of said processor 22a The scheduling unit of the shell 22a receives the gettask call and starts the task selection. In step S2 the task scheduling unit determines whether the current task is still runnable, i.e. able to run. A task is able to run when there are data in the input stream and room in the output stream available. The task scheduling unit further determines whether the running budget of the current task is greater than zero. If the current task is runnable and the running budget thereof is greater than zero, the task scheduling unit returns the task_ID of the current task to the associated processor 12a in step S3, indicating that the processor 12a is supposed to continue processing the current task. The processor 12a will then continue with the processing of the current task until issuing the next gettask call.

However, if the running budget is zero or if the current task is not runnable, e.g. due to a lack of data in the input stream, than the flow jumps to step S4. Here the task scheduling unit must select the task to be processed next by the processor 12a. The task scheduling unit selects the next task from a list of runnable tasks in a round-robin order. In step S5 the running budget for the next task is set to the corresponding set-up parameter from the task table and in step S6 the task_ID of this task is returned to the processor 12a The processor 12a will then start with the processing of the next task until issuing the next gettask call.

Next, the actual selection of the next task will be described in more detail. This task selection can either be carried out as soon as the scheduling unit receives the gettask call from the processor 12a or the scheduling unit can start the selecting process before receiving the next gettask call so that the selection result, i.e. the next task, is already at hand when the scheduling unit receives the gettask call, such that the processor does not need to wait for the return of its gettask call. This becomes possible since the processor 12a issues the gettask call at regular intervals, wherein said intervals being the processing steps.

Preferably, the scheduling unit of the shells 22a, 22b comprise a stream table and a task table. The scheduling unit uses the task table for the configuration and administration of the different tasks mapped to its associated processor 12a, 12b. These local tables allow fast access. The table contains a line of fields for each task. The table preferably contains an index in the stream table to the first stream being associated to the task, an enable bit indicating whether the task is allowed to run and has the required resources available, and a budget field to parameterise the task scheduling unit and to assure processing justice among the tasks.

The task scheduling unit repeatedly inspects all streams in the stream table one by one to determine whether they are runnable. A stream is considered as allowed to run, i.e. is runnable, if it contains nonzero space or if its schedule flag is not set and its blocked flag is not set. Thereafter, the task scheduling unit inspects all tasks in the task table one by one if they are runnable. A task is considered runnable, if all its associated stream are runnable and the task enable flag is set. The next step for the task scheduling unit is to select one of the runnable tasks from said task table, which is to be processed next by the processor 12a.

A separate process decrements the running budget each time slice, defined by a clock divider in the shell 22a, 22b.

The shell implements the task scheduling unit in dedicated hardware, as the task switch rate is too high for a software implementation. The task scheduling unit must provide an answer to a gettask request in a few clock cycles.

The task scheduling unit may also prepare a proposal for a new task in a background process to have this immediately available when a gettask request arrives. Furthermore, it keeps track of a ‘running budget’ counter to control the duration that each task remains scheduled an the processor.

Task selection is allowed to lag behind with respect to the actual status of the buffers. Only the active task decreases the space in the stream buffer, and all external synchronization putspace messages increase the space in the buffer. Therefore, a task that is ready to run remains runnable while external synchronization messages update the buffer space value. Thus, the scheduler can be implemented as a pull mechanism, where the scheduler periodically loops over the stream table and updates the runnability flags for each task, regardless of the incoming synchronization messages. This separation between scheduling and synchronization allows a less time critical implementation of the scheduler, while minimizing latency of synchronization commands.

The gettask request may also contain a ‘active_blocked’ flag, raised by the processor when the processing step terminated prematurely due to blocking an data. This flag causes the ‘runnable’ status of the active task to be cleared immediately. This quick feedback compensates for the latency in the scheduler process, and allows the scheduler to immediately respond with a different task.

The system architecture according to the preferred embodiment of the invention offers a cost-effective and scalable solution for re-using computation hardware over a set of media applications that combine real-time and dynamic behaviour. The task scheduling unit in each processor shell observes available workload and recognizes data dependent behaviour, while guaranteeing each task a minimum computation budget and a maximum sleep time. Very high task switch rates are supported with a hardware implementation of the shells. The scheduling is distributed. The tasks of each processor are scheduled independently by their respective shells.

FIG. 4 depicts an illustration of the process of reading and writing and its associated synchronisation operations. From the processor point of view, a data stream looks like an infinite tape of data having a current point of access. The getspace call issued from the processor asks permission for access to a certain data space ahead of the current point of access as depicted by the small arrow in FIG. 3a. If this permission is granted, the processor can perform read and write actions inside the requested space, i.e. the framed window in FIG. 3b, using variable-length data as indicated by the n_bytes argument, and at random access positions as indicated by the offset argument.

If the permission is not granted, the call returns false. After one or more getspace calls—and optionally several read/write actions—the processor can decide if is finished with processing or some part of the data space and issue a putspace call. This call advances the point-of-access a certain number of bytes, i.e. n_bytes2 in FIG. 3d, ahead, wherein the size is constrained by the previously granted space.

FIG. 4 depicts an illustration of the cyclic FIFO memory. Communicating a stream of data requires a FIFO buffer, which preferably has a finite and constant size. Preferably, it is pre-allocated in memory, and a cyclic addressing mechanism is applied for proper FIFO behaviour in the linear memory address range.

A rotation arrow 50 in the centre of FIG. 4 depicts the direction on which getspace calls from the processor confirm the granted window for read/write, which is the same direction in which putspace calls move the access points ahead. The small arrows 51, 52 denote the current access points of tasks A and B. In this example A is a writer and hence leaves proper data behind, whereas B is a reader and leaves empty space (or meaningless rubbish) behind. The shaded region (A1, B1) ahead of each access point denote the access window acquired through getspace operation.

Tasks A and B may proceed at different speeds, and/or may not be serviced for some periods in time due to multitasking. The shells 22a, 22b provide the processors 12a, 12b on which A and B run with information to ensure that the access points of A and B maintain their respective ordering, or more strictly, that the granted access windows never overlap. It is the responsibility of the processors 12a, 12b to use the information provided by the shell 22a, 22b such that overall functional correctness is achieved. For example, the shell 22a, 22b may sometimes answer a getspace requests from the processor false, e.g. due to insufficient available space in the buffer. The processor should then refrain from accessing the buffer according to the denied request for access.

The shells 22a, 22b are distributed, such that each can be implemented close to the processor 12a, 12b that it is associated to. Each shell locally contains the configuration data for the streams which are incident with tasks mapped on its processor, and locally implements all the control logic to properly handle this data. Accordingly, a local stream table is implemented in the shells 22a, 22b that contains a row of fields for each stream, or in other words, for each access point.

To handle the arrangement of FIG. 4, the stream table of the processor shells 22a, 22b of tasks A and B each contain one such line, holding a ‘space’ field containing a (maybe pessimistic) distance from its own point of access towards the other point of access in this buffer and an ID denoting the remote shell with the task and port of the other point-of-access in this buffer. Additionally said local stream table may contain a memory address corresponding to the current point of access and the coding for the buffer base address and the buffer size in order to support cited address increments.

These stream tables are preferably memory mapped in small memories, like register files, in each of said shells 22. Therefore, a getspace call can be immediately and locally answered by comparing the requested size with the available space locally stored. Upon a putspace call this local space field is decremented with the indicated amount and a putspace message is sent to the another shell which holds the previous point of access to increment its space value. Correspondingly, upon reception of such a put message from a remote source the shell 22 increments the local field. Since the transmission of messages between shells takes time, cases may occur where both space fields do not need to sum up to the entire buffer size but might momentarily contain the pessimistic value. However this does not violate synchronisation safety. It might even happen in exceptional circumstances that multiple messages are currently on their way to destination and that they are serviced out of order but even in that case the synchronisation remains correct.

FIG. 5 shows a mechanism of updating local space values in each shell and sending ‘putspace’ messages. In this arrangement, a getspace request, i.e. the getsspace call, from the processor 12a, 12b can be answered immediately and locally in the associated shell 22a, 22b by comparing the requested size with the locally stored space information. Upon a putspace call, the local shell 22a, 22b decrements its space field with the indicated amount and sends a putspace message to the remote shell. The remote shell, i.e. the shell of another processor, holds the other point-of-access and increments the space value there. Correspondingly, the local shell increments its space field upon reception of such a putspace message from a remote source.

The space field belonging to point of access is modified by two sources: it is decrement upon local putspace calls and increments upon received putspace messages. If such an increment or decrement is not implemented as atomic operation, this could lead to erroneous results. In such a case separated local-space and remote-space field might be used, each of which is updated by the single source only. Upon a local getspace call these values are then subtracted. The shells 22 are always in control of updates of its own local table and performs these in an atomic way. Clearly this is a shell implementation issue only, which is not visible to its external functionality.

If getspace call returns false, the processor is free to decide an how to react. Possibilities are, a) the processor my issue a new getspace call with a smaller n_bytes argument, b) the processor might wait for a moment and then try again, or c) the processor might quit the current task and allow another task on this processor to proceed.

This allows the decision for task switching to depend upon the expected arrival time of more data and the amount of internally accumulated state with associated state saving cost. For non-programmable dedicated hardware processors, this decision is part of the architectural design process. State saving and restore is the responsibility of the processor, not of the task scheduler. Processors can implement state saving and restore in various ways, for example:
The processor has explicit state memory for each task local to the processor.
The processor saves and restores state to shared memory using the getspace, read, write, and putspace primitives.
The processor saves and restores state to external memory via an interface that is separate from the processor-shell interface.

The implementation and operation of the shells 22 do not to make differentiations between read versus write ports, although particular instantiations may make these differentiations. The operations implemented by the shells 22 effectively hide implementation aspects such as the size of the FIFO buffer, its location in memory, any wrap-around mechanism on address for memory bound cyclic FIFO's, caching strategies, cache coherency, global I/O alignment restrictions, data bus width, memory alignment restrictions, communication network structure and memory organisation.

Preferably, the shell 22a, 22b operate on unformatted sequences of bytes. There is no need for any correlation between the synchronisation packet sizes used by the writer and a reader which communicate the stream of data. A semantic interpretation of the data contents is left to the processor. The task is not aware of the application graph incidence structure, like which other tasks it is communicating to and on which processors these tasks mapped, or which other tasks are mapped on the same processor.

In high-performance implementations of the shells 22 the read call, write call, getspace call, putspace calls can be issued in parallel via the read/write unit and the synchronisation unit of the shells 22a, 22b. Calls acting on the different ports of the shells 22 do not have any mutual ordering constraint, while calls acting on identical ports of the shells 22 must be ordered according to the caller task or processor. For such cases, the next call from the processor can be launched when the previous call has returned, in the software implementation by returning from the function call and in hardware implementation by providing an acknowledgement signal.

A zero value of the size argument, i.e. n_bytes, in the read call can be reserved for performing pre-fetching of data from the memory to the shells cache at the location indicated by the port_ID—and offset-argument. Such an operation can be used for automatic pre-fetching performed by the shell. Likewise, a zero value in the write call can be reserved for a cache flush request although automatic cache flushing is a shell responsibility.

Optionally, all five operations accept an additional last task_ID argument. This is normally the small positive number obtained as result value from an earlier gettask call. The zero value for this argument is reserved for calls which are not task specific but relate to processor control.

In another embodiment based on the preferred embodiment according to FIG. 2 and FIG. 3 the function-specific dedicated processors can be replaced with programmable processors while the other features of the preferred embodiment remain the same. According to the program implemented on the programmable processor each processor is specialised to perform a limited range of stream processings. Each processor is arranged—according to its programming—to apply the same processing operation repeatedly to successive data objects of a stream. Preferably, the task scheduler is also implemented in software which can run on the associated processor.

1. A data processing system, comprising:
a first and at least one second processor for processing a stream of data objects, said first processor being arranged to pass data objects from a stream of data objects to the second processor, said second processors being multi-tasking processors, capable of interleaved processing of a first and second task, wherein said first and second tasks process a first and second stream of data objects, respectively;
a communication network; and
a task scheduling means for each of said second processors, said task scheduling means being operatively arranged between said second processor and said communication network;
wherein the task scheduling means of each of said second processors controls the task scheduling of said second processor.

2. Data processing system according to claim 1, wherein
said second processors are arranged to handle multiple inbound and outbound streams and/or multiple streams per task.

3. Data processing system according to claim 1, wherein
said task scheduling means are adapted to determine the next task to be processed by said second processor upon receiving a request from said second processor and to forward an identification of said next task to said second processor,
wherein said second processor requests a next task at successive intervals; said intervals representing the processing steps of said second processor.

4. Data processing system according to claim 1, wherein
the communication between said second processors and their associated task scheduling means is a master/slave communication, said second processors acting as masters.

5. Data processing system according to claim 1, wherein
said second processors being function-specific dedicated processors performing a set of parameterised stream processing functions.

6. Data processing system according to claim 1, wherein said task scheduling means comprises:
a stream table for storing parameters of each stream associated with the tasks mapped on the associated processor, said stream table containing various administrative data per stream, and/or
a task table for administrating the different tasks associated to said second processor, said task table containing an index to the stream table indicating which streams are associated to said task, an enable flag for each task indicating whether the task is allowed to run, and/or a budget counter indicating an available processing budget for each task.

7. Data processing system according to claim 6, wherein
said stream table contains an amount of valid data for reading, an amount of available room for writing, information on whether the running task is blocked on reading or writing to said stream, and/or configuration information relating said stream to a task.

8. Data processing system according to claim 6, wherein
said task scheduling means is adapted to check all streams in said stream table and to determine which of said streams allow task progress,
wherein a stream allows progress if a) the stream has valid data for reading or available room for writing, b) the task did not request more valid data or room than is available in the stream, and/or c) option a), b) are configured as irrelevant for task progress.

9. Data processing system according to claim 6, wherein
said task scheduling means is adapted to check all tasks in said task table and to determine which of said tasks are allowed to run,
wherein a task is allowed to run if all the streams associated to said task allow task progress and the task is configured to be runnable.

10. Data processing system according to claim 6, wherein
said task scheduling means is adapted to select one task from a plurality of configured tasks as the task to be processed next.

11. Data processing system according to claim 1, wherein
said task scheduling means comprises a budget counter means for controlling the resource budget of the current task.

12. Data processing system according to claim 1, wherein
said task scheduling means is adapted to utilize a resource budget parameter per task, wherein said resource budget parameter limits the time in which a processor is continuously occupied with the related task.

13. Data processing system according to claim 12, wherein
said task scheduling means is adapted to select a task which is to be processed next after the current task, upon receiving a request from said second processor
wherein the current task is allowed to continue if the current task is still allowed to run and its resource budget is not depleted;
wherein otherwise a next task as determined by said task scheduling means is selected as new current task.

14. Data processing system according to claim 13, wherein
said task scheduling means is adapted to select the next task that is allowed to run in round-robin order.

15. Data processing system according to claim 1, wherein
said task scheduling means is adapted to select a task which is to be processed next before said second processor request a next task, so that the identification of the selected next task can be immediately returned to said second processor.

16. Data processing system according to claim 12, wherein
said budget counter is updated by events based upon a real-time clock.

17. Data processing system according to claim 12, wherein
said task scheduling means is adapted to replenish the budget of a next task when it is selected to become the current task.

18. Data processing system according to claim 1, wherein
said second processors being a programmable processors performing a set of programmable parameterised stream processing functions.

19. A task scheduler for a data processing system, said system comprising a first and at least one second processor for processing a stream of data objects, said first processor being arranged to pass data objects from a stream of data objects to the second processor, a communication network and a memory, wherein
the task scheduler is adapted to be associated to one of said second processors,
the task scheduler is being adapted to be operatively arranged between said second processor and said communication network; and
the task scheduler is adapted to control the task scheduling of said associated second processor.

20. A task scheduler according to claim 19, wherein
said task scheduler is adapted to determine the next task to be processed by said second processor upon receiving a request from said second processor and to forward an identification of said next task to said second processor,
wherein said second processor requests a next task at predetermined intervals; said intervals representing the processing steps of said second processor.

21. A task scheduler according to claim 19, further comprising:
a stream table for storing parameters of each stream associated with the tasks mapped on the associated processor, said stream table containing various administrative data per stream, and/or
a task table for administrating the different tasks associated to said second processor, said task table containing an index to the stream table indicating which streams are associated to said task, an enable flag for each task indicating whether the task is allowed to run, and/or a budget counter indicating an available processing budget for each task.

22. A task scheduler according to claim 19, wherein
said stream table contains an amount of valid data for reading, an amount of available room for writing, information on whether the running task is blocked on reading or writing to said stream, and/or configuration information relating said stream to a task

23. A task scheduler according to claim 21, being
adapted to check all streams in said stream table and to determine which of said streams allow task progress,
wherein a stream allows progress if a) the stream has valid data for reading or available room for writing, b) the task did not request more valid data or room than is available in the stream, and/or c) option a), b) are configured as irrelevant for task progress.

24. A task scheduler according to claim 21, being
adapted to check all tasks in said task table and to determine which of said tasks are allowed to run,
wherein a task is allowed to run if all the streams associated to said task allow task progress and the task is configured to be runnable.

25. A task scheduler according to claim 24, being
adapted to select a task which is to be processed next after the current task, upon receiving a request from said second processor;
wherein the current task is allowed to continue if the current task is still allowed to run and the budget counter in said task table is nonzero,
wherein otherwise the next task as determined by said task scheduling means is selected as current task and the budget counter is reset.

26. A task scheduler according to claim 21, being
adapted to select one task from a plurality of configured tasks as the task to be processed next.

27. A task scheduler according to claim 19, comprising
a budget counter means for controlling the resource budget of the current task.

28. A task scheduler according to claim 19, being
adapted to utilize a resource budget parameter per task, wherein said resource budget parameter limits the time in which a processor is continuously occupied with the related task.

29. A task scheduler according to claim 28, being adapted to select a task which is to be processed next after the current task, upon receiving a request from said second processor
wherein the current task is allowed to continue if the current task is still allowed to run and its resource budget is not depleted;
wherein otherwise a next task as determined by said task scheduling means is selected as new current task.

30. A task scheduler according to claim 29, being
said task scheduling means is adapted to select the next task that is allowed to run in round-robin order.

31. A task scheduler according to claim 28, being
adapted to replenish the budget of a next task when it is selected to become the current task.

32. A method for task scheduling in a data processing system, said system comprising a first and at least one second processor for processing a stream of data objects, said first processor being arranged to pass data objects from a stream of data objects to the second processor, a communication network, said system having a task scheduler for each of said second processors; whereby
the task scheduler controls the task scheduling of said second processor

33. A method for task scheduling according to claim 32, further comprising the steps of:
determining the next task to be processed by said second processor upon receiving a request from said second processor, and
forwarding an identification of said next task to said second processor,
wherein said second processor requests a next task at successive intervals; said intervals representing the processing steps of said second processor.

34. A method for task scheduling according to claim 32, wherein
the communication between said second processors and their associated task scheduling means is a master/slave communication, said second processors acting as masters.

35. A method for task scheduling according to claim 32, further comprising the steps of:
storing parameters of each stream associated with the tasks mapped on the associated processor a stream table, said stream table containing various administrative data per stream, and/or
administrating the different tasks associated to said second processor a task table, said task table containing an index to the stream table indicating which streams are associated to said task, an enable flag for each task indicating whether the task is allowed to run, and/or a budget counter indicating an available processing budget for each task.

36. A method for task scheduling according to claim 35, wherein
said stream table contains an amount of valid data for reading, an amount of available room for writing, information on whether the running task is blocked on reading or writing to said stream, and/or configuration information relating said stream to a task

37. A method for task scheduling according to claim 35, further comprising the steps of:
checking all streams in said stream table and to determine which of said streams allow task progress, wherein
a stream allows progress if a) the stream has valid data for reading or available room for writing, b) the task did not request more valid data or room than is available in the stream, and/or c) option a), b) are configured as irrelevant for task progress.

38. A method for task scheduling according to claim 35, further comprising the steps of:
checking all tasks in said task table and determining which of said tasks are allowed to run,
wherein a task is allowed to run if all the streams associated to said task allow task progress and the task is configured to be runnable.

39. A method for task scheduling according to claim 35, 36, 37 or 38, further comprising the step of:
selecting one task from a plurality of configured tasks as the task to be processed next.

40. A method for task scheduling according to claim 32, further comprising the step of:
for controlling the resource budget of the current task.

41. A method for task scheduling according to claim 32, further comprising the step of:
utilizing a resource budget parameter per task, wherein said resource budget parameter limits the time in which a processor is continuously occupied with the related task.

42. A method for task scheduling according to claim 41, further comprising the steps of:
selecting a task which is to be processed next after the current task, upon receiving a request from said second processor
wherein the current task is allowed to continue if the current task is still allowed to run and its resource budget is not depleted;
wherein otherwise a next task as determined by said task scheduling means is selected as new current task.

43. A method for task scheduling according to claim 42, further comprising the step of:
selecting the next task that is allowed to run in round-robin order.

44. A method for task scheduling according to claim 32, further comprising the step of:
selecting a task which is to be processed next before said second processor request a next task, so that the identification of the selected next task can be immediately returned to said second processor.

45. A method for task scheduling according to claim 41, further comprising the step of:
updating said budget counter by events based upon a real-time clock.

46. A method for task scheduling according to claim 41, further comprising the steps of:
replenishing the budget of a next task when it is selected to become the current task.

47. A method for task scheduling according to claim 1, further comprising the step of:
implementing the task scheduler on a programmable second processor.
